(19) United States
(12) Patent Application Publication
(10) Pub. No.: US 2025/0269735 A1
(43) Pub. Date: Aug. 28, 2025

(54) METHOD OF CONTROLLING RETARDATION OF A VEHICLE, COMPUTER PROGRAM, COMPUTER-READABLE MEDIUM, CONTROL ARRANGEMENT, AND VEHICLE

(71) Applicant: Scania CV AB, Södertälje (SE)

(72) Inventors: Oskar NILSSON, Johanneshov (SE); Casper Johansson, Hägersten (SE)

(73) Assignee: Scania CV AB, Södertälje (SE)

(21) Appl. No.: 19/044,790

(22) Filed: Feb. 4, 2025

(30) Foreign Application Priority Data
Feb. 23, 2024 (SE) 2450223-9

(51) Int. Cl. B60L 15/20

(52) U.S. Cl. CPC B60L 15/2009; B60L 2240/423; B60L 2240/486

(57) ABSTRACT

A method of controlling retardation of a vehicle is disclosed, wherein the method is performed by a control arrangement, and wherein the vehicle comprises a transmission and an electric machine operably connected to driven wheels of the vehicle via the transmission. The method comprises the step of, in a retardation phase of the vehicle, limiting a braking torque provided by the electric machine during a time period following a downshift in the transmission such that the braking power applied to the driven wheels after the downshift is within a threshold range of the braking power applied to the driven wheels prior to the downshift. The present disclosure further relates to a computer program, a computer-readable, a control arrangement, and a vehicle.

### TECHNICAL FIELD

The present disclosure relates to a method of controlling retardation of a vehicle. The present disclosure further relates to a computer program, a computer-readable medium, a control arrangement configured to control retardation of a vehicle, as well as a vehicle comprising a control arrangement.

### BACKGROUND

Vehicles have traditionally been powered using an internal combustion engine. However, the use of electric drive for vehicles provides many advantages, especially regarding local emissions. Such vehicles comprise one or more electric machines configured to provide motive power to the vehicle. These types of vehicles can be divided into the categories pure electric vehicles and hybrid electric vehicles. Pure electric vehicles, sometimes referred to as battery electric vehicles, only-electric vehicles, and all-electric vehicles, comprise a pure electric powertrain and comprise no internal combustion engine and therefore produce no emissions in the place where they are used.

A hybrid electric vehicle comprises two or more distinct types of power sources, such as an internal combustion engine and an electric propulsion system. The combination of an internal combustion engine and an electric propulsion system provides advantages with regard to energy efficiency, partly because of the poor energy efficiency of an internal combustion engine at lower power output levels. Moreover, some hybrid electric vehicles are capable of operating in pure electric drive when wanted, such as when driving in certain areas.

In at least partially electric vehicles, such as in pure electric vehicles and hybrid electric vehicles, the electricity is usually stored in a number of battery packs each comprising a number of rechargeable battery cells. Some different types of battery cells are used, such as lithium-ion battery cells, lithium polymer battery cells, as well as other types of rechargeable battery cells. Additionally, some vehicles are equipped with fuel cells capable of converting hydrogen to electricity. These fuel cells generate electricity through a chemical reaction between hydrogen and oxygen, which can complement the use of rechargeable battery packs in supporting the vehicle's electrical systems and propulsion.

The electric machine of an at least partially electric vehicle can be used to regeneratively brake the vehicle. Regenerative braking refers to a process where the electric machine is used as a generator during braking. Instead of merely converting the vehicle's kinetic energy into heat through friction, as conventional brakes do, regenerative braking captures the braking energy and converts it into electrical energy. This electrical energy is then fed back into the vehicle's battery pack, recharging it to a certain extent.

Regenerative braking has several benefits. It extends the driving range of electric and hybrid vehicles by recovering energy that would otherwise be lost. It also reduces the wear and tear on the mechanical braking system, leading to lower maintenance costs and longer intervals between brake servicing. Furthermore, by enhancing the energy efficiency of electric and hybrid vehicles, regenerative braking contributes to the reduction of carbon emissions and the vehicles' environmental impact, aligning with the broader goals of using electric drive technology to mitigate local emissions and decrease reliance on fossil fuels.

The effectiveness of regenerative braking, and consequently the amount of braking power the electric machine can generate, is intrinsically linked to the rotational speed of the electric machine and, by extension, the speed of the vehicle itself. That is, as the vehicle decelerates during a retardation phase, the rotational speed of the electric motor decreases which can reduce the available braking power of the electric machine. Moreover, such a reduction in rotational speed can reduce the regenerative braking system's capacity to generate electricity.

One way to increase the regenerative braking capacity is to increase the transmission ratio between the electric machine and the wheels, such as by performing a downshift in a gearbox arranged between the electric machine and the wheels. In this manner, the regenerative braking capacity and the braking power provided by the electric machine can be increased during a retardation phase of the vehicle.

However, a downshift during a retardation phase of a vehicle can cause a sudden increase in braking power, potentially leading to wheel slip. Wheel slip can compromise the vehicle's operational safety due to reduced force transfer between the wheel and road surface, both longitudinally and laterally. Moreover, wheel slip may induce excessive wear and tear on the wheels and the surface upon which the vehicle travels. Furthermore, a sudden increase in braking power provided by the electric machine may cause a jerky operation of the vehicle, which impairs passenger comfort and can cause cargo to shift.

### SUMMARY

It is an object of the present invention to overcome, or at least alleviate, at least some of the above-mentioned problems and drawbacks. The object is achieved by the subject-matter of the appended independent claim(s).

According to a first aspect of the present disclosure, the object is achieved by a method of controlling retardation of a vehicle, wherein the method is performed by a control arrangement, and wherein the vehicle comprises a transmission and an electric machine operably connected to driven wheels of the vehicle via the transmission. The method comprises the step of, in a retardation phase of the vehicle:
limiting a braking torque provided by the electric machine during a time period following a downshift in the transmission such that the braking power applied to the driven wheels after the downshift is within a threshold range of the braking power applied to the driven wheels prior to the downshift.

Thereby, a method is provided having conditions for maintaining the braking power provided by the electric machine with reducing speeds of the vehicle while avoiding jerky operation of the vehicle as well as wheel slip. This is because the method comprises the step of limiting the braking torque provided by the electric machine during the time period following the downshift in the transmission such that the braking power applied to the driven wheels after the downshift is within the threshold range of the braking power applied to the driven wheels prior to the downshift.

In other words, a method is provided having conditions for maintaining a regenerative braking capacity at reducing speeds of the vehicle, while ensuring a smooth retardation of the vehicle thereby enhancing passenger comfort, preventing cargo shifting, and maintaining the operational safety of the vehicle.

Accordingly, a method is provided overcoming, or at least alleviating, at least some of the above-mentioned problems and drawbacks. As a result, the above-mentioned object is achieved.

Optionally, the method comprises the steps of:
inputting a braking power request, and
setting the duration of the time period based on a difference between the braking power request and the braking power applied to the driven wheels prior to the downshift.

Thereby, an adaptive method is provided capable of obtaining a smooth transition in braking power while providing conditions for obtaining a higher braking power if needed based on the braking power request.

Optionally, the duration of the time period may be decreased upon large differences between the braking power request and the braking power applied to the driven wheels prior to the downshift, and may be increased upon small differences between the braking power request and the braking power applied to the driven wheels prior to the downshift. In this manner, smooth operation of the vehicle can be ensured while providing conditions for obtaining a higher braking power if needed based on the braking power request.

Optionally, the method comprises the steps of:
inputting a braking power request, and
setting the size of the threshold range based on a difference between the braking power request and the braking power applied to the driven wheels prior to the downshift.

Thereby, an adaptive method is provided capable of obtaining a smooth transition in braking power while providing conditions for obtaining a higher braking power if needed based on the braking power request.

Optionally, the size of the threshold range may be increased upon large differences between the braking power request and the braking power applied to the driven wheels prior to the downshift, and may be decreased upon small differences between the braking power request and the braking power applied to the driven wheels prior to the downshift. In this manner, smooth operation of the vehicle can be ensured while conditions are provided for obtaining a higher braking power if needed based on the braking power request.

Optionally, the threshold range is smaller than 25% or is smaller than 12%.

Thereby, smooth operation of the vehicle can be ensured in which jerky operation of the vehicle and wheel slip caused by a sudden increase in braking power is avoided while the regenerative braking capacity of the electric machine can be maintained with reducing speeds of the vehicle.

Optionally, the method comprises the steps of:
inputting a braking power request, and
   at an end of the time period:
initiating an incremental or gradual change of the braking torque provided by the electric machine in a direction towards the braking power request.

Thereby, an adaptive method is provided capable of obtaining a smooth transition in braking power while providing conditions for obtaining a higher braking power if needed based on the braking power request.

Optionally, the method comprises the step of:
setting the rate of the incremental or gradual change of the braking torque based on the magnitude of the difference between the braking power request and a current braking power applied to the driven wheels at the end of the time period.

Thereby, an adaptive method is provided capable of obtaining a smooth transition in braking power while providing conditions for obtaining a higher braking power if needed based on the braking power request.

The step of setting the rate of the incremental or gradual change of the braking torque may be performed such that the incremental or gradual change is set to higher rates in case of large magnitudes of differences between the braking power request and a current braking power applied to the driven wheels at the end of the time period, and vice versa. In this manner, smooth transition in braking power and thereby smooth operation of the vehicle can be ensured while providing conditions for obtaining a higher braking power if needed based on the braking power request.

According to a second aspect of the present disclosure, the object is achieved by a computer program comprising instructions to cause the control arrangement according to the second aspect of the present disclosure to execute the steps of the method according to some embodiments of the first aspect of the present disclosure. Since the computer program comprises instructions to cause the control arrangement to carry out the method according to some embodiments described herein, a computer program is provided which provides conditions for overcoming, or at least alleviating, at least some of the above-mentioned drawbacks. As a result, the above-mentioned object is achieved.

According to a third aspect of the present disclosure, the object is achieved by a computer-readable medium having stored thereon the computer program according to the second aspect of the present disclosure. Since the computer-readable medium comprises instructions to cause the control arrangement to carry out the method according to some embodiments described herein, a computer-readable medium is provided which provides conditions for overcoming, or at least alleviating, at least some of the above-mentioned drawbacks. As a result, the above-mentioned object is achieved.

According to a fourth aspect of the present disclosure, the object is achieved by a control arrangement configured to control retardation of a vehicle, wherein the method is performed by a control arrangement, and wherein the vehicle comprises a transmission and an electric machine operably connected to driven wheels of the vehicle via the transmission. The control arrangement is configured to, in a retardation phase of the vehicle:
limit a braking torque provided by the electric machine during a time period following a downshift in the transmission such that the braking power applied to the driven wheels after the downshift is within a threshold range of the braking power applied to the driven wheels prior to the downshift.

Thereby, a control arrangement is provided having conditions for maintaining the braking power provided by the electric machine with reducing speeds of the vehicle while avoiding jerky operation of the vehicle as well as wheel slip. This is because the control arrangement is configured to limit the braking torque provided by the electric machine during the time period following the downshift in the transmission such that the braking power applied to the driven wheels after the downshift is within the threshold range of the braking power applied to the driven wheels prior to the downshift.

In other words, a control arrangement is provided having conditions for maintaining a regenerative braking capacity at reducing speeds of the vehicle, while ensuring a smooth retardation of the vehicle thereby enhancing passenger comfort, preventing cargo shifting, and maintaining the operational safety of the vehicle.

Accordingly, a control arrangement is provided overcoming, or at least alleviating, at least some of the above-mentioned problems and drawbacks. As a result, the above-mentioned object is achieved.

It will be appreciated that the various embodiments described for the method are all combinable with the control arrangement as described herein. That is, the control arrangement according to the fourth aspect of the invention may be configured to perform any one of the method steps of the method according to the first aspect of the invention.

According to a fifth aspect of the present disclosure, the object is achieved by a vehicle comprising a transmission and an electric machine operably connected to driven wheels of the vehicle via the transmission, and wherein the vehicle comprises a control arrangement configured to, in a retardation phase of the vehicle:
limit a braking torque provided by the electric machine during a time period following a downshift in the transmission such that the braking power applied to the driven wheels after the downshift is within a threshold range of the braking power applied to the driven wheels prior to the downshift.

Thereby, a vehicle is provided having conditions for maintaining the braking power provided by the electric machine with reducing speeds of the vehicle while avoiding jerky operation of the vehicle and wheel slip caused by a sudden increase in braking power. This is because the control arrangement of the vehicle is configured to limit the braking torque provided by the electric machine during the time period following the downshift in the transmission such that the braking power applied to the driven wheels after the downshift is within the threshold range of the braking power applied to the driven wheels prior to the downshift.

In other words, a vehicle is provided having conditions for maintaining a regenerative braking capacity at reducing speeds of the vehicle, while ensuring a smooth retardation of the vehicle thereby enhancing passenger comfort, preventing cargo shifting, and maintaining the operational safety of the vehicle.

Accordingly, a vehicle is provided overcoming, or at least alleviating, at least some of the above-mentioned problems and drawbacks. As a result, the above-mentioned object is achieved.

Optionally, the vehicle is a heavy road vehicle, such as a truck or a bus. Thereby, a heavy road vehicle is provided having at least some of the above-mentioned advantages.

Further features of, and advantages with, the present invention will become apparent when studying the appended claims and the following detailed description.

### BRIEF DESCRIPTION OF THE DRAWINGS

Various aspects of the present disclosure, including its particular features and advantages, will be readily understood from the example embodiments discussed in the following detailed description and the accompanying drawings, in which:

FIG. 1 schematically illustrates a vehicle according to some embodiments,

FIG. 2 illustrates a graph with a vertical axis indicating a braking torque provided by an electric machine and a braking power applied to driven wheels in a retardation phase of the vehicle illustrated in FIG. 1, and a horizontal axis showing the rotational speed of the electric machine of the vehicle illustrated in FIG. 1,

FIG. 3 schematically illustrates a method of controlling retardation of a vehicle, and

FIG. 4 illustrates a computer-readable medium.

### DETAILED DESCRIPTION

Aspects of the present disclosure will now be described more fully. Like reference signs refer to like elements throughout. Well-known functions or constructions will not necessarily be described in detail for brevity and/or clarity.

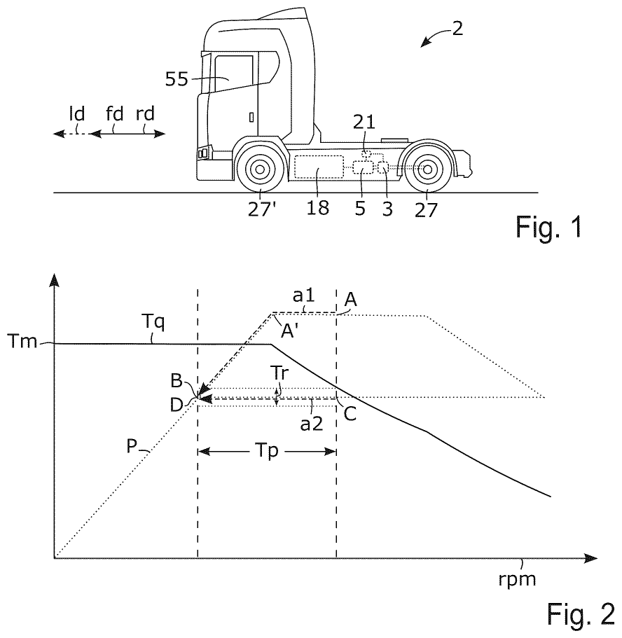

FIG. 1 schematically illustrates a vehicle 2 according to some embodiments. According to the illustrated embodiments, the vehicle 2 is a truck, i.e., a type of heavy road vehicle, as well as a type of heavy commercial vehicle. According to further embodiments, the vehicle 2, as referred to herein, may be another type of heavy or lighter type of manned or unmanned vehicle for land-based propulsion such as a lorry, a bus, a construction vehicle, a tractor, a car, or the like.

The vehicle 2 comprises a transmission 3 and an electric machine 5. The electric machine 5 is operably connected to driven wheels 27 of the vehicle 2 via the transmission 3. That is, the electric machine 5 is configured to provide motive power to the vehicle 2 via the transmission 3 and the driven wheels 27 of the vehicle 2. According to the illustrated embodiments, the vehicle 2 further comprises two non-driven wheels 27′, which according to the illustrated embodiments constitute front-wheels of the vehicle 2. Moreover, the driven wheels 27 of the vehicle 2 constitute rear-wheels of the vehicle 2. However, according to further embodiments, the vehicle 2 may comprise another configuration of driven and non-driven wheels.

According to the illustrated embodiments, the vehicle 2 is a pure electric vehicle comprising the electric machine 5 as the only means of providing motive power to the vehicle 2 and no internal combustion engine. The vehicle 2 may comprise more than one electric machine 5. According to such embodiments, at least two different electric machines may be operably connected to wheels 27, 27′ at the same wheel axle of the vehicle 2 or may be operably connected to wheels 27, 27′ at different wheel axles of the vehicle 2.

The transmission 3 is controllable to provide at least two different transmission ratios between the electric machine 5 and the driven wheels 27 of the vehicle 2. The at least two different transmission ratios may also be referred to as at least two different gear steps or at least two different gear ratios. The transmission 3, as referred to herein, may also be referred to as a gearbox.

The vehicle 2 comprises an electrical energy storage system 18 configured to store electrical energy, wherein the electric machine 5 is configured to operate using electricity from the electrical energy storage system 18. The electrical energy storage system 18 may comprise a number of battery packs each comprising a number of rechargeable battery cells, such as lithium-ion battery cells, lithium polymer battery cells, or the like. As an alternative, or in addition, the vehicle 2 may comprise a pressure tank, such as a cryogenic pressure tank, configured to accommodate hydrogen gas. According to such embodiments, the vehicle 2 may comprise one or more fuel cells configured to generate electricity through a chemical reaction between oxygen and hydrogen from the pressure tank.

In FIG. 1, a forward moving direction fd and a reverse moving direction rd of the vehicle 2 are indicated. Each of the forward moving direction fd and the reverse moving direction rd is parallel to a longitudinal direction Id of the vehicle 2. The reverse moving direction rd is opposite to the forward moving direction fd.

The electric machine 5 is controllable to perform regenerative braking of the vehicle 2. In other words, the electric machine 5 is controllable to apply a braking torque to the driven wheels 27 via the transmission 3, generate electricity upon rotation, and wherein the at least part of the generated electricity is used for charging the electrical energy storage system 18 of the vehicle 2.

The vehicle 2 further comprises a control arrangement 21. According to the embodiments illustrated in FIG. 1, the control arrangement 21 is operably connected to the electric machine 5 and the transmission 3 of the vehicle 2.

FIG. 2 illustrates a graph with a vertical axis indicating a braking torque Tq provided by the electric machine 5 and a braking power P applied to the driven wheels 27 in a retardation phase of the vehicle 2 illustrated in FIG. 1, and a horizontal axis showing the rotational speed rpm of the electric machine 5 of the vehicle 2 illustrated in FIG. 1. Below, simultaneous reference is made to FIG. 1 and FIG. 2, if not indicated otherwise.

In FIG. 2, a number of different time-based events A-D are indicated. The events A-D are separated by time, wherein event A occurs first, followed sequentially by events A′, B, C, and D. Even though time is not an explicitly labelled axis on the graph of FIG. 2, each event from A to D is inherently separated by time from the others, which can be inferred from the nature of vehicle dynamics, as will be explained in the following.

At event A, a vehicle retardation phase of the vehicle 2 is initiated wherein the electric machine 5 applies a braking torque Tq to the driven wheels 27. A first dashed arrow a1 is illustrated in FIG. 2 between event A and event B. As seen at a first portion of the dashed arrow a1 between the events A and A′, a substantially constant braking power P is applied to the driven wheels 27. This is possible because the braking torque Tq from the electric machine 5 can be increased to compensate for the decreasing rotational speed rpm of the electric machine 5. However, at the event A′, the braking torque Tq provided by the electric machine 5 reaches a maximum level Tm. Therefore, the braking power P applied to the driven wheels 27 declines with the reducing rotational speed rpm of the electric machine 5 between the events A′ and B.

At event B, a downshift in the transmission 3 is initiated and at event C, the downshift is completed. The wording downshift, as referred to herein, means that the transmission 3 is controlled to provide an increased transmission ratio between the electric machine 5 and the driven wheels 27 of the vehicle 2 after the downshift as compared to prior to the downshift. As seen in FIG. 2, the rotational speed rpm of the electric machine 5 is higher at event C than at event B.

According to embodiments herein, the control arrangement 21 is configured to, in a retardation phase of the vehicle 2, limit a braking torque Tq provided by the electric machine 5 during a time period Tp following a downshift in the transmission 3 such that the braking power P applied to the driven wheels 27 after the downshift is within a threshold range Tr of the braking power P applied to the driven wheels 27 prior to the downshift.

In this manner, jerky operation of the vehicle 2 can be avoided as well as wheel slip of the driven wheels 27 of the vehicle 2 caused by a sudden increase in braking power P applied to the driven wheels 27. This control can thus enhance passenger comfort, prevent cargo shifting, and maintain the operational safety of the vehicle 2.

As understood from the above described, in the example depicted in FIG. 2, the braking power P applied to the driven wheels 27 prior to the downshift is indicated at event B, i.e., the time-based event at which the downshift in the transmission 3 is initiated.

In the example depicted in FIG. 2, the time period Tp is indicated between the events C and D. As understood from the above described, the events C and D represents temporally separated events, i.e., events separated by the duration of the time period Tp. A second dashed arrow a2 is illustrated in FIG. 1 between event C and event D. As seen in FIG. 2, according to the depicted example, a constant braking power P is applied to the driven wheels 27 during the time period Tp. Therefore, in the depicted example of FIG. 2, the braking power P applied to the driven wheels 27 is the same at event D as it is at events B and C.

According to some embodiments, the control arrangement 21 is configured to input a braking power request and is configured to set the duration of the time period Tp based on a difference between the braking power request and the braking power P applied to the driven wheels 27 prior to the downshift.

The control arrangement 21 may be configured to set the duration of the time period Tp such that shorter durations are set in case of large differences between the braking power request and the braking power P applied to the driven wheels 27 prior to the downshift, and vice versa.

The braking power request may be inputted from a brake actuator arranged in a driver environment 55 of the vehicle 2, such as from a brake pedal arrangement, and/or from an at least partially autonomous driving system of the vehicle 2.

According to some embodiments, the control arrangement 21 may be configured to set size of the threshold range Tr based on a difference between the braking power request and the braking power P applied to the driven wheels 27 prior to the downshift. The control arrangement 21 may be configured to set size of the threshold range Tr such that larger threshold ranges Tr are set in case of large differences between the braking power request and the braking power P applied to the driven wheels 27 prior to the downshift, and vice versa.

According to the embodiments illustrated in FIG. 2, the threshold range Tr is approximately 5% which means that the control arrangement 21 limits the braking torque Tq provided by the electric machine 5 during the time period Tp following the downshift in the transmission 3 such that the braking power P applied to the driven wheels 27 after the downshift differs by less than 5% from the braking power P applied to the driven wheels 27 prior to the downshift. According to further embodiments, the threshold range Tr may be smaller than 25% or may be smaller than 12%.

According to some embodiments, the control arrangement 21 may be configured to, at an end of the time period Tp, initiate an incremental or gradual change of the braking torque Tq provided by the electric machine 5 in a direction towards the braking power request. In FIG. 2, the time period Tp ends at the event D. However, an incremental or gradual change of the braking torque Tq provided by the electric machine 5 in a direction towards a braking power request has not been illustrated in FIG. 2 for reasons of brevity and clarity.

Moreover, the control arrangement 21 may be configured to set the rate of the incremental or gradual change of the braking torque Tq based on the magnitude of the difference between the braking power request and a current braking power P applied to the driven wheels 27 at the end of the time period Tp. The control arrangement 21 may be configured to set the rate of the incremental or gradual change of the braking torque Tq such that higher rates are obtained in case of large magnitudes of differences between the braking power request and a current braking power P applied to the driven wheels 27 at the end of the time period Tp, and vice versa.

The control arrangement 21 may be configured to limit the braking torque Tq provided by the electric machine 5 by performing an electrical control of the electric machine 5 such that a lower braking torque Tq is provided by the electric machine 5 as compared to if no limitation was made.

According to some embodiments, the control arrangement 21 is configured to initiate a downshift in the transmission 3 in a retardation phase of the vehicle 2. The control arrangement 21 may for example initiate such a downshift when the available braking power P applied to the driven wheels 27 reaches below a threshold level, when the available braking power P applied to the driven wheels 27 reaches below a braking power request, and/or when the rotational speed rpm of the electric machine 5 reaches below a threshold level.

The control arrangement 21 may then, as explained above, limit the braking torque Tq provided by the electric machine 5 during a time period Tp following the downshift in the transmission 3 such that the braking power P applied to the driven wheels 27 after the downshift is within a threshold range Tr of the braking power P applied to the driven wheels 27 prior to the downshift.

According to further embodiments, the control arrangement 21 may be operably connected to another device or system of the vehicle 2 and may be configured to receive data from such another device or system indicated that a downshift in the transmission 3 is ongoing, imminent, or completed. In such embodiments, the control arrangement 21 may be configured to limit the braking torque Tq provided by the electric machine 5 during a time period Tp following a downshift in the transmission 3, according to the above described, in response to the receipt of such data.

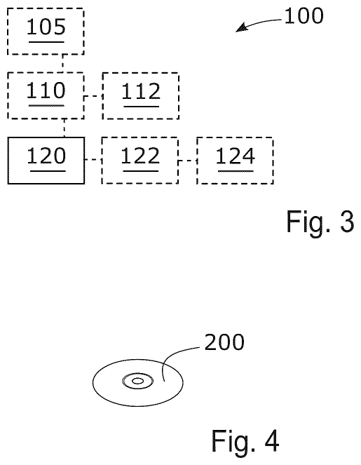

FIG. 3 schematically illustrates a method 100 of controlling retardation of a vehicle. The vehicle may be a vehicle 2 as explained with reference to FIG. 1 and FIG. 2. Therefore, below, simultaneous reference is made to FIG. 1-FIG. 3, if not indicated otherwise.

The method 100 is a method of controlling retardation of a vehicle 2, wherein the method 100 is performed by a control arrangement 21, and wherein the vehicle 2 comprises a transmission 3 and an electric machine 5 operably connected to driven wheels 27 of the vehicle 2 via the transmission 3, and wherein the method 100 comprises the step of, in a retardation phase of the vehicle 2:
limiting 120 a braking torque Tq provided by the electric machine 5 during a time period Tp following a downshift in the transmission 3 such that the braking power P applied to the driven wheels 27 after the downshift is within a threshold range Tr of the braking power P applied to the driven wheels 27 prior to the downshift.

As seen in FIG. 3, the method 100 may comprise the steps of:
inputting 105 a braking power request, and
setting 110 the duration of the time period Tp based on a difference between the braking power request and the braking power P applied to the driven wheels 27 prior to the downshift.

Moreover, as seen in FIG. 3, the method 100 may comprise the steps of:
inputting 105 a braking power request, and
setting 112 the size of the threshold range Tr based on a difference between the braking power request and the braking power P applied to the driven wheels 27 prior to the downshift.

According to embodiments herein, the threshold range Tr may be smaller than 25% or may be smaller than 12%.

According to some embodiments, the method 100 comprises the steps of:
inputting 105 a braking power request, and
   at an end of the time period Tp:
initiating 124 an incremental or gradual change of the braking torque Tq provided by the electric machine 5 in a direction towards the braking power request.

Furthermore, according to some embodiments, the method 100 may comprise the step of:
setting 122 the rate of the incremental or gradual change of the braking torque Tq based on the magnitude of the difference between the braking power request and a current braking power P applied to the driven wheels 27 at the end of the time period Tp.

It will be appreciated that the various embodiments described for the method 100 are all combinable with the control arrangement 21 as described herein. That is, the control arrangement 21 may be configured to perform any one of the method steps 105, 110, 112, 120, 122, and 124 of the method 100.

FIG. 4 illustrates a computer-readable medium 200 comprising instructions which, when executed by a computer, cause the computer to carry out the method 100 according to some embodiments of the present disclosure. According to some embodiments, the computer-readable medium 200 comprises a computer program comprising instructions which, when the program is executed by a computer, cause the computer to carry out the method 100 according to some embodiments. The computer may be comprised in the control arrangement 21.

One skilled in the art will appreciate that the method 100 of controlling retardation of a vehicle 2 may be implemented by programmed instructions. These programmed instructions are typically constituted by a computer program, which, when it is executed in the control arrangement 21, ensures that the control arrangement 21 carries out the desired control, such as the method steps 105, 110, 112, 120, 122, and 124 described herein. The computer program is usually part of a computer program product which comprises a suitable digital storage medium on which the computer program is stored, such as the computer-readable medium 200 illustrated in FIG. 4. In other words, the computer program product may be a computer readable medium 200 and the computer program may be stored in the computer readable medium 200.

The control arrangement 21 may comprise a computer which may take the form of substantially any suitable type of hardware or hardware/firmware device implemented using processing circuity such as, but not limited to, a processor, Central Processing Unit (CPU), a controller, an arithmetic logic unit (ALU), a digital signal processor, an Application Specific Integrated Circuit (ASIC), a circuit for digital signal processing (digital signal processor, DSP), a microcomputer, a field programmable gate array (FPGA), a System-on-Chip (SoC), a programmable logic unit, a microprocessor, an application-specific integrated circuit, or any other device capable of electronically performing operations in a defined manner, or other processing logic that may interpret and execute instructions. The herein utilised expression “computer” may represent a processing circuitry comprising a plurality of processing circuits, such as, e.g., any, some or all of the ones mentioned above.

The control arrangement 21 may further comprise a memory unit, wherein the computer may be connected to the memory unit, which may provide the computer with, for example, stored program code and/or stored data which the computer may need to enable it to do calculations. The computer may also be adapted to store partial or final results of calculations in the memory unit. The memory unit may comprise a physical device utilised to store data or programs, i.e., sequences of instructions, on a temporary or permanent basis. According to some embodiments, the memory unit may comprise integrated circuits comprising silicon-based transistors. The memory unit may comprise e.g. a memory card, a flash memory, a USB memory, a hard disc, or another similar volatile or non-volatile storage unit for storing data such as e.g. ROM (Read-Only Memory), PROM (Programmable Read-Only Memory), EPROM (Erasable PROM), EEPROM (Electrically Erasable PROM), etc. in different embodiments.

The control arrangement 21 is connected to components of the vehicle 2 for receiving and/or sending input and output signals. These input and output signals may comprise waveforms, pulses, or other attributes which the input signal receiving devices can detect as information and which can be converted to signals processable by the control arrangement 21. These signals may then be supplied to the computer. One or more output signal sending devices may be arranged to convert calculation results from the computer to output signals for conveying to other parts of the vehicle's control system and/or the component or components for which the signals are intended. Each of the connections to the respective components of the vehicle 2 for receiving and sending input and output signals may take the form of one or more from among a cable, a data bus, e.g. a CAN (controller area network) bus, a MOST (media orientated systems transport) bus or some other bus configuration, or a wireless connection.

In the embodiments illustrated, the vehicle 2 comprises a control arrangement 21 but might alternatively be implemented wholly or partly in two or more control arrangements, two or more control arrangements, or two or more control units.

Control systems in modern vehicles generally comprise a communication bus system consisting of one or more communication buses for connecting a number of electronic control units (ECUs), or controllers, to various components on board the vehicle. Such a control system may comprise a large number of control units and taking care of a specific function may be shared between two or more of them. Vehicles and engines of the type here concerned are therefore often provided with significantly more control arrangements than depicted in FIG. 1, as one skilled in the art will surely appreciate.

The computer-readable medium 200 may be provided for instance in the form of a data carrier carrying computer program code for performing at least some of the method steps 105, 110, 112, 120, 122, and 124 according to some embodiments of the method 100 when being loaded into one or more computers of the control arrangement 21. The data carrier may be, e.g. a CD ROM disc, as is illustrated in FIG. 4, or a ROM (read-only memory), a PROM (programable read-only memory), an EPROM (erasable PROM), a flash memory, an EEPROM (electrically erasable PROM), a hard disc, a memory stick, an optical storage device, a magnetic storage device or any other appropriate medium such as a disk or tape that may hold machine readable data in a non-transitory manner. Accordingly, in some embodiments, the computer-readable medium 200 may be a non-transitory computer-readable medium, such as a tangible electronic, magnetic, optical, infrared, electromagnetic, and/or semiconductor system, apparatus, and/or device. The computer-readable medium 200 may furthermore be provided as computer program code on a server and may be downloaded to the control arrangement 21 remotely, e.g., over an Internet or an intranet connection, or via other wired or wireless communication systems.

It is to be understood that the foregoing is illustrative of various example embodiments and that the invention is defined only by the appended independent claims. A person skilled in the art will realize that the example embodiments may be modified, and that different features of the example embodiments may be combined to create embodiments other than those described herein, without departing from the scope of the present invention, as defined by the appended independent claims.

As used herein, the term “comprising” or “comprises” is open-ended, and includes one or more stated features, elements, steps, components, or functions but does not preclude the presence or addition of one or more other features, elements, steps, components, functions, or groups thereof.

1. A method of controlling retardation of a vehicle, wherein the method is performed by a control arrangement, and wherein the vehicle comprises a transmission and an electric machine operably connected to driven wheels of the vehicle via the transmission, and wherein the method comprises the step of, in a retardation phase of the vehicle:
limiting a braking torque provided by the electric machine during a time period following a downshift in the transmission such that a braking power applied to the driven wheels after the downshift is within a threshold range of the braking power applied to the driven wheels prior to the downshift.

2. The method according to claim 1, wherein the method comprises the steps of:
inputting a braking power request; and
setting a duration of the time period based on a difference between the braking power request and the braking power applied to the driven wheels prior to the downshift.

3. The method according to claim 1, wherein the method comprises the steps of:
inputting a braking power request; and
setting a size of the threshold range based on a difference between the braking power request and the braking power applied to the driven wheels prior to the downshift.

4. The method according to claim 1, wherein the threshold range is one of: (i) smaller than 25% or (ii) smaller than 12%.

5. The method according to claim 1, wherein the method comprises the steps of:
inputting a braking power request; and
at an end of the time period:
initiating an incremental or gradual change of the braking torque provided by the electric machine in a direction towards the braking power request.

6. The method according to claim 5, wherein the method comprises the step of:
setting a rate of the incremental or gradual change of the braking torque based on a magnitude of the difference between the braking power request and a current braking power applied to the driven wheels at the end of the time period.

7. A computer program product stored on a non-transitory computer-readable medium, said computer program product for controlling retardation of a vehicle, wherein the vehicle comprises a transmission and an electric machine operably connected to driven wheels of the vehicle via the transmission, wherein said computer program product comprising computer instructions to cause one or more computing devices to:
limiting a braking torque provided by the electric machine during a time period following a downshift in the transmission such that a braking power applied to the driven wheels after the downshift is within a threshold range of the braking power applied to the driven wheels prior to the downshift.

8. (canceled)

9. A control arrangement configured to control retardation of a vehicle, wherein the vehicle comprises a transmission and an electric machine operably connected to driven wheels of the vehicle via the transmission, and wherein the control arrangement is configured to, in a retardation phase of the vehicle:
limit a braking torque provided by the electric machine during a time period following a downshift in the transmission such that a the braking power applied to the driven wheels after the downshift is within a threshold range of the braking power applied to the driven wheels prior to the downshift.

10. A vehicle comprising a transmission and an electric machine operably connected to driven wheels of the vehicle via the transmission, and wherein the vehicle comprises a control arrangement is configured to, in a retardation phase of the vehicle:
limit a braking torque provided by the electric machine during a time period following a downshift in the transmission such that a braking power applied to the driven wheels after the downshift is within a threshold range of the braking power applied to the driven wheels prior to the downshift.

11. The vehicle according to claim 10, wherein the vehicle is a heavy road vehicle.

12. The control arrangement according to claim 9, wherein the control arrangement is further configured to:
input a braking power request; and
set a duration of the time period based on a difference between the braking power request and the braking power applied to the driven wheels prior to the downshift.

13. The control arrangement according to claim 9, wherein the control arrangement is further configured to:
input a braking power request; and
set a size of the threshold range based on a difference between the braking power request and the braking power applied to the driven wheels prior to the downshift.

14. The control arrangement according to claim 9, wherein the threshold range is one of: (i) smaller than 25% or (ii) smaller than 12%.

15. The control arrangement according to claim 9, wherein the control arrangement is further configured to:
input a braking power request; and
at an end of the time period:
initiate an incremental or gradual change of the braking torque provided by the electric machine in a direction towards the braking power request.

16. The control arrangement according to claim 9, wherein the control arrangement is further configured to:
set a rate of the incremental or gradual change of the braking torque based on a magnitude of the difference between the braking power request and a current braking power applied to the driven wheels at the end of the time period.
